(19) United States
(12) Patent Application Publication
(10) Pub. No.: US 2002/0068884 A1
(43) Pub. Date: Jun. 6, 2002

(54) Osteoarticular repositioning devices and methodologies

(76) Inventor: Todd Alexander Alviso, Laguna Niguel, CA (US)

Correspondence Address: TODD A. ALVISO, D.C., 7890 MARIPOSA TRAIL, YUCCA VALLEY, CA, 92284, US

(21) Appl. No.: 09/834,991

(22) Filed: Apr. 13, 2001

Related U.S. Application Data
(63) Continuation-in-part of application No. 09/325,275, filed on Jun. 3, 1999.

(51) Int. Cl. A61H 1/02; A61H 5/00; A61H 7/00

(52) U.S. Cl. 601/1; 601/84

(57) ABSTRACT

A device and procedure for self-treating the bony architectural alignment of human feet in a non-standing position. The methodology utilizes a known biomechanical adjustment device called the Activator Adjustment Instrument 30 when performed by a caregiver, or new self administered devices. The non-standing version of this previously unknown device provides a surface board 40 with a at least one rubber, or similar material, stylus tips or stimulating members 46 connected to an automated impulse based mechanism for delivering the impulses necessary to adjust the foot's bony architecture. Whether applied through the Activator Adjustment Instrument or the self-administered device, preferably the stylus tips are sized and employed to adjust a succession of regions of the arches of the a person's medial longitudinal arches, lateral longitudinal arches, and transverse arches including the longitudinal center, thereby to assist in restoring and maintaining the natural architecture of the foot. The sequence of point stimulation on the feet is essential to obtaining the intended results of the invention.

### CROSS-REFERENCES TO RELATED APPLICATIONS

This invention uses the transmission of my co-pending application Ser. No. 09/325,275, Filed Jun. 3, 1999. This CIP application claims the benefit of patent application Ser. No. 09/325,275, filed Jun. 3, 1999.

### BACKGROUND

1. Field of Invention

This invention relates to biomechanical adjustment devices and methodologies for manipulating the hard and soft tissues of the human foot, most specifically to restore the natural intended alignment and functioning of the human body.

2. Discussion of Prior Art

As any living body ages, and particularly as a human body ages, it usually experiences a variety of increasingly severe aches and pains. To at least some degree this can be attributed to the aging process. But often such aches and pains result from maladjustments in the biomechanical functioning of the body itself. The bone and muscular structure of the human body evolved (Note: The evolutionary principles expressed in this application are reflective of the anatomical record associated with the theory of human evolution) over many thousands of years, and in an environment far different than that typically encountered by most people today. For example, the human foot evolved while walking barefoot on natural terrain. Now, though, most people wear shoes and walk on a hard, flat surface. Both of these conditions are unnatural; the raised heel used as part of most shoes adds to the unnatural forces applied to the foot. Since the body is adaptable, it will strive to adjust to these unnatural forces. Because the heel of the foot is raised by the typical shoe, the muscles and joints above it must adjust; this can lead to significant problems in the ankle, knee, hip, lower back and other biomechanical structures of the body, which in turn often results in what most people view as typical aches and pains. Such afflictions have been treated in various ways. Modern allopathic medicine tends to view them as site specific, and treat the afflicted knee, lower back or whatever other area happens to be the locus of the pain, often with pharmaceutical drugs, surgery or a recommendation for physical therapy. Chiropractic and osteopathic manipulative therapies usually attribute the pain to a misalignment of the hard and soft tissues of the spine or extremities, and therefore manipulate the skeletal and muscular structures to restore proper alignment of these structures. Both such approaches have their advocates, and have experienced success. But they also have experienced failures, too.

Experience in treating patients by the applicant have imparted what may be a unique understanding of the interrelationship of biomechanics and the natural energy balances of the human body. Using relatively conventional chiropractic techniques led to the incorporation of such techniques of the methodology known as applied kinesiology, often referred to as AK. Applied kinesiology offers a direct and effective way to gauge the afflicted areas of the body and the results of the treatment by testing specific muscle groups related to the affliction. “Strong” and “weak” manual muscle test responses represent amongst other things, a compensatory pattern of muscular strengths and weaknesses maintained by the body in attempts to balance the structurally compromised human frame. This pattern of compensatory structural imbalances is referred to as “serial distortion.” Such muscle testing procedures are certainly helpful to the care giver; it also can be used to make clear to the person being treated the effectiveness of the treatment.

As these techniques developed, it also became clear that the site of many of the body's problems was centered in the feet. With great regularity, a person would be treated to minimize or eliminate the conditions which occasioned the treatment, only to return a short while later with the same condition. Clearly there was some underlying cause that was regenerating the affliction with depressing regularity. It now appears that this cause is centered in, or significantly involves the feet. They seem to determine to a significant degree the nature of the energy flow in the rest of the body. If they are functioning naturally, which is to say—if they are functioning as they were designed by nature to function, then the rest of the body seems to assume, or readjust to, its natural state. “As below, so above” appears to be quite true in this context. For that reason, how the foot functions seems to be critical to the biomechanical functioning of the rest of the body.

Throughout human history, many devices have been designed to provide mechanical stimulation to the hard and soft tissues of the human body in attempts to relieve pain or improve biomechanical function. Many of these devices are classified as massage tools or devices and are typically self-administered or applied by a trained massage technician. Several types of devices and procedure methodologies have been proposed—for example, U.S. Pat. Nos. 5,322,056 (6/1994), 6,013,042 (1/2000), 5,490,821 (2/1996), 5,263,474 (11/1993). These devices and methodologies were typically used in a generalized manner of application without any specific procedural application necessary to obtain the desired effects. Although many of the devices have been used on the feet and were effective in providing general therapeutic benefits associated with massage to the “soft-tissues” of the user, they did not address the problem of the derangement of the bony architecture . This loss of the natural intended alignment and functioning of the bony architecture is referred to by healthcare professionals as “joint subluxation.”

This problem was partially addressed by the use of certain “knobbed” devices that the user would stand on which were designed to penetrate deeper into the tissues to provide relief through stimulation of acupressure reflex zones, typically used in oriental medicine or foot reflexology. Examples of such devices and methodologies that have been proposed are in U.S. Pat. No. 4,852,553 (8/1989) and DE Pat. No. DE3,228,638 (2/1984). However, these treatment procedures and devices were not directed to specifically manipulate the bony architecture of the feet in any particular manner. Japan patent JP11,137,630 (5/1999) utilizes a general non-specific massage and support to the feet while standing on the device, however does not apply any specific manipulation procedure for appropriate bony re-alignment. The exercising appliance and methodology in U.S. Pat. No. 1,981,379 to Thomson and Mulhern, Apr. 8, 1933 addresses this need to manipulate the bony architecture of the human foot. However, the design of the apparatus and methodology for usage was limited in its effectiveness to appropriately restore the natural intended alignment and functioning of the entire foot complex.

With today's understanding in the field of human health and biomechanics nearly 68 years later, we are better able to evaluate the effectiveness of such devices through physical objective measurements and clinical outcome assessments that can accurately differentiate the effectiveness of certain therapeutic procedures and devices. In the past, such therapeutic devices have not used manual muscle testing procedures to measure their effectiveness on the structure and function of the human body. Those familiar with AK know that simple muscle tests can quickly and clearly reveal the effectiveness of different treatments. Healthcare professionals who evaluate and treat neuromusculoskeletal conditions know that simple physical examination procedures can also reveal the effectiveness of different treatments. It is through these standard procedures and methodologies of evaluation commonly utilized in today's healthcare practices that indicate the need to provide a device and methodology that can be utilized to positively affect the structure and function of the human body with both subjective and objective measurable improvements to the user. Nevertheless all devices or treatment methodologies practiced or utilized heretofore known suffer from a number of disadvantages:

(a) They do not provide a specific methodology or procedure for manipulating the individual bones of the feet to affect the entire foot complex. They utilize a general application method for massage stimulation or manipulation.

(b) The use of the devices and methodologies do not produce an “optimal biomechanical state” of the human body, as measured through standard chiropractic, orthopedic, neurological and manual muscle testing procedures.

(c) The devices and methodologies do not direct treatment to restore all aspects of the natural arches of the human foot, which requires a specific manipulation to the individual bones that make up the arch regions.

(d) Standard manipulative procedures to the individual bones of the feet through chiropractic or osteopathic manipulative therapy, whether specifically applied or used as general mobilization procedures to the feet or other regions of the body does not produce an “optimal biomechanical state.”

(e) Standard manual massage techniques or pressure point therapy to the feet or other regions of the body will not produce an optimal biomechanical state.

(f) Shoe inserts, therapeutic insoles or shoe orthotic devices typically placate the dynamic action of the arches of the human foot, are worn in inappropriate footwear, and do not restore the bony architecture of the foot to achieve an optimal biomechanical state.

(g) massage devices were not designed to specifically conform to the three unique arches of the foot (medial longitudinal, lateral longitudinal, transverse metatarsal).

### OBJECTS AND ADVANTAGES

Recent discoveries from the research and clinical evaluations performed by the applicant, a doctor of chiropractic, reveal that the human body can be adjusted to achieve an “optimal biomechanical state” or functioning. In this state, among other things, posture is erect, breathing is deep and relaxed, and muscles exhibit their normal strength. When a person's body is not in an optimal biomechanical state, posture degrades, usually to a somewhat bent position, breathing is shallow, and muscles do not attain their normal strength. An optimal biomechanical state is capable of many health benefits by affecting motion to every bodily system through pain free movement, restoration of body harmony, and a rested state of mind.

The Neutral Balance Effect (NBE) is new terminology introduced by this applicant used to describe this optimal biomechanical state, and the health benefits associated with such a state. The term is a derived from the optimal alignment state of the foot and ankle joint, most specifically the talus bone, previously described in standard medical text as the “neutral talar position”. Hence, the term “Neutral Balance Effect” when describing the widespread effects that occur throughout the body that is achieved by maintaining this optimal body alignment state.

The structure of the human foot, and the ligaments, tendons and muscles that affect functioning of the human foot, have been known for a long time. In general, the foot consists of three groups of bones, the large tarsal bones (the talus or ankle bone and the calcaneus or heel bone) the small tarsal bones, and the long anterior bones (the metatarsals and phalanges). In their normal orientation, these bones and their associated ligaments, tendons and muscles hold the foot in a position that exhibits various arches, including the medial longitudinal arch (extending from the large tarsal bones along the medial length of the foot across the small tarsal bones to the metatarsal bones), the lateral longitudinal arch (extending generally longitudinally across the small tarsal bones of the foot and their connection to the metatarsal bones) and the metatarsal transverse arch (extending generally transversely across the metatarsal bones and their connections to the phalanges up to the small tarsal bones).

For the foot to function as intended by nature, all of these arches must be free to respond to the pressures exerted during walking. The modern shoe and unnatural hard, flat walking surfaces do not permit this, however, which in turn seems to be a significant cause of biomechanical problems. Certainly these problems can be minimized by a proper shoe design (or by simply walking barefoot or unshod on appropriate surfaces). But if one has worn a typical modern style shoe for any significant period, or walks barefoot on hard, flat unnatural surfaces and particularly if one is experiencing biomechanical problems, simply using the correct shoe or walking barefoot, will not eliminate those problems. The foot needs to be retrained into its natural state imposed on it by the modern shoe and unnatural surface environments, and very likely considerable repetition of this treatment until the foot has regained and is stable in its natural state. Such treatments may need to be performed regularly—a few times day if necessary if the person has “lost their adjustment” as determined by testing methods discussed later in this application. Expecting a person to see a chiropractic doctor or other treatment provider that often is unrealistic and until the present invention or methodology would not have attained an optimal biomechanical state even with frequented visits if they did not perform the applicant's new methodology. It is optimal that the user of these devices or methodologies, after performing the method, wear biomechanical conducive footwear as disclosed in the applicant's “Shoe Assembly” U.S. patent issued on Feb. 8, 2000, as U.S. Pat. No. 6,021,588 which maintains this optimal biomechanical state when walking on any typical surfaces. This is necessary to reduce the number of self-treatments the individual will need to perform, and will help to expedite the structural repositioning of the hard and soft-tissue elements of the body. Theoretically and preferably, if the individual used the devices and methodologies only once, and then wore the aforementioned biomechanical conducive shoes when walking on hard surfaces, and when unshod maintained their optimal state by walking on appropriate surfaces, the devices and methodologies disclosed would only need to be used once. A way to permit a person to manipulate their own foot, especially its arches, is needed for these reasons. But until this invention there was no known way for a person to self-treat their own feet in this manner to effectively manipulate the bony architecture of the feet and obtain an optimal biomechanical state. Indeed in the past few perceived the desirability of such treatment.

The present invention arises out of many years experience in treating the typical aches and pains of the human body, traumatic injuries, and physiological states associated with health and disease. Such treatments have imparted what may be considered a unique view of the neurological and biomechanical forces of the human body. Since the present invention arises out of that understanding, it will be explained in the context of this view of human biomechanics and neurological forces. Whatever the accuracy of that view, though, the invention has been shown through use to be extraordinarily effective. Put differently, the present invention should not be judged by whatever may be the perceived accuracy of the biomechanical and neurological understanding here stated, but rather by the effectiveness of the disclosed and claimed structure, device and method.

Several objects and advantages of the present invention are:

(a) to provide a device and methodology for a person to effectively manipulate their own feet, and particularly to manipulate their feet to optimize the beneficial results that can be obtained by doing so;

(b) to produce an optimal biomechanical state or functioning of the human body that can be objectively and subjectively evidenced through clinical evaluation utilizing standard chiropractic, orthopedic, neurological and manual muscle testing procedures determining the effectiveness of the devices or methodologies on the human body;

(c) to provide a treatment methodology and devices directed to restore all regions of the three main arches of the foot, requiring a specific manipulative procedure to the individual bones that comprise the arch regions;

(d) to provide a specific treatment methodology that may be implemented with the use of certain devices applied by a trained healthcare professional that can effectively manipulate the individual bones of the feet comprising the arches, in a non-standing position producing what is referred to as an optimal biomechanical state;

(e) to provide a specific treatment device and methodology that provides effective manipulation to the bony architecture of the human foot in order to produce an optimal biomechanical state;

(f) to provide a device and methodology that provides the user with improved alignment and functioning of the human foot structures, restoring a dynamic responsive state to the arches and an optimal biomechanical state;

(g) to provide mechanical stimulation devices designed that specifically conform to the three arches of the foot (medial longitudinal, lateral longitudinal, transverse metatarsal).

These and other objects and advantages of the present invention will be apparent to those skilled in this field from the following detailed description.

### SUMMARY OF THE INVENTION

The preferred device of the invention as cross referenced in application Ser. No. 09/325,275, filed Jun. 3, 1999, is designed to assist in the biomechanical adjustment of the human foot. The new device and method is disclosed later in this application. The original invention of the cross referenced application includes a device which has an association of pairs of pad surfaces, each of the pair including a first surface for applying pressure to the medial longitudinal arch of a foot, a second surface for applying pressure to the transverse arch of the foot. Preferably each surface is provided by a different pad, and sufficient pads are provided and located to apply pressure simultaneously to both feet while the person being treated is standing on the pads. Also, in the preferred construction of the device the pads are attached to a resilient floorboard or pane, and are moveable to permit the spacing between the pads to be adjusted to approximate the distance between the hip joints of the user.

A second embodiment of the original device employs only a pair of pads, each pad having a surface of a size and shape to permit the application of pressure to the surfaces previously stated. The pair of pads are connected together and adjustable along a strap to permit them to be spaced to approximate the distance between the hip joints of the user.

The preferred method of treating the bony architecture, cross-referenced in the related application, utilizes a substantially bilateral simultaneous adjustment method of the human foot using at least one pair of raised pads. It includes the steps of applying a definite but comfortable pressure to the medial longitudinal arch to each of the user's feet, and then applying a definite but comfortable pressure to the lateral longitudinal arch of the user's feet, and then applying a definite but comfortable pressure to the transverse arch of the user's feet, thereby to effect an adjustment of the foot's bony architecture. Preferably the user stands on both pads of the pair at the same time to simultaneously treat both feet. Also, preferably the pads are of a size, relative to the feet to be treated, that they apply pressure to only a portion of the arch, then to a second portion of the arch, and then to a third portion of the arch. Further, it is preferred that the user, when employing the treatment method of the invention and uses pairs of pads, first removes the foot corresponding to the handedness of the user from its pad before removing the other foot from its pad of the pair. Therefore, a right handed individual would preferably remove their right foot the pair of pads first when changing positions. By using the pads in this preferred manner, the user obtains maximum benefit from the treatment. Although, th is position changing sequence is not necessary to achieve the results of the invention, except for the final position.

A second method of a specific manipulative procedure, but applying the pressures or stimulation to all points on one foot first, and then stimulating all points on the other foot, which is the process of this methodological invention, may be performed by a healthcare practitioner trained in manual medicine procedures utilizing an “activator adjusting instrument” or “reflex adjustment gun” to specifically manipulate the individual bones of the arches. This procedural methodology utilizes the same points of stimulation when performing the adjustment procedures on the present invention devices with a bilateral simultaneous stance. However, when using these other adjustment instruments, the procedure is performed with the patient in a non-weight bearing position of the feet. Stimulation is applied by a stylus tip 30 to all points on one foot first, specifically the foot that corresponds to the handedness side of the body. Then all points are stimulated on the foot of the non-handedness side of the body. For examplea right handed individual would have all points of stimulation performed on the right foot first, and then would have the same corresponding points stimulated on the left foot.

The same unilateral point stimulation method can be used in a non-weight bearing position with a device utilized to provide an impulse sufficient to adjust the foot's bony architecture, delivered through a fairly rigid foam or rubber stylus tip or stimulating member 46, or the like and is designed as a self-treatment device. The user moves his feet individually into each position over the stylus. This device has a motorized unit 44 or similar means such as a pneumatic trigger mechanism, or spring loaded mechanism or solenoid used to elicit the stimulus, causing the stylus tip to engage the tissues. A release button 47 is depressed by the user to elicit the automated stimulus. Two stylus tips are provided, one for each foot, spaced approximately hip's width apart. Surface board 40 is of a material sufficiently resilient to maintain the bony architectural alignment of the foot once the procedure is applied. A surface board 40 is of a material such as cross-linked polyethylene foam of a durometry of about 3 to 4 pounds per cubic foot being suffice mounted to a base container 42. Electric cord with plug 43 may provide power to the unit, or similar means may be used such as battery operated or rechargeable systems. This device is intended for use while the user is in the seated position. Lower limb paralysis patients may benefit from this device by using their upper limbs to lift and position the feet over the corresponding pad positions. The surface board may be angulated or tilted for comfort by raising or lowering the adjustable supports 50.

### BRIEF DESCRIPTION OF THE DRAWINGS

The invention will be further described in connection with the accompanying drawings in which:

FIG. 1 is a plan view of a first embodiment of the cross-referenced invention;

FIG. 2 is a perspective view of one of the pads used in the device shown in FIG. 1;

FIG. 3 is a cross-sectional view of a pad taken on lines III-III of FIG. 1;

FIG. 4 is a cross-sectional view of a pad taken on lines IV-IV of FIG. 1;

FIG. 5 is a view partly in cross-section and partly in elevation, of a portion of the device taken on lines V-V of FIG. 1;

FIG. 6 is a diagrammatic view showing the orientation of a human foot during use of one of the pad pairs, or stylus tips, FIG. 6 shows a triangular shape pad, however a circular shaped pad or stylus tip as shown in FIGS. 7 and 8 is assumed to contact the portion of the foot's medial arch;

FIG. 7 is another diagrammatic view showing the orientation of a foot during use of a second of the pad pairs, or single or paired stylus tip;

FIG. 8 is a third diagrammatic view showing the orientation of a foot during use of a third of the pad pairs, or single or paired stylus tip;

FIG. 9 is a perspective view of a second embodiment of the cross-referenced device;

FIG. 10 is a plan view of an activator adjusting instrument or reflex adjustment gun utilized in an embodiment of the methodological procedure of the present invention.

FIG. 11 is a plan view of an embodiment of a device utilizing the non-simultaneous point stimulation method, performed in a substantially non-weight bearing position of the users feet;

FIG. 12 is a side view of the of the device, without the stylus tip activated;

FIG. 13 is a cross-sectional view taken midline between the pair of stylus tips of the device utilized in the present methodology, demonstrating the foot position with the activation of the stylus tip.

### DETAILED DESCRIPTION

In its simplest, most basic form, the cross-referenced application's from Ser. No. 09/325,275, filed Jun. 3, 1999 discloses an invention providing at least one pair of pads on which the user stands to treat particular portions of the bony architecture of the users feet. Preferably, a plurality of pairs of pads of a certain size relative to the size of the user's foot are provided; the pads are used in a particular manner to manipulate the structure of the various arches of the foot to achieve the significant benefits associated with the realignment of the foot's structure to its normal or natural architecture.

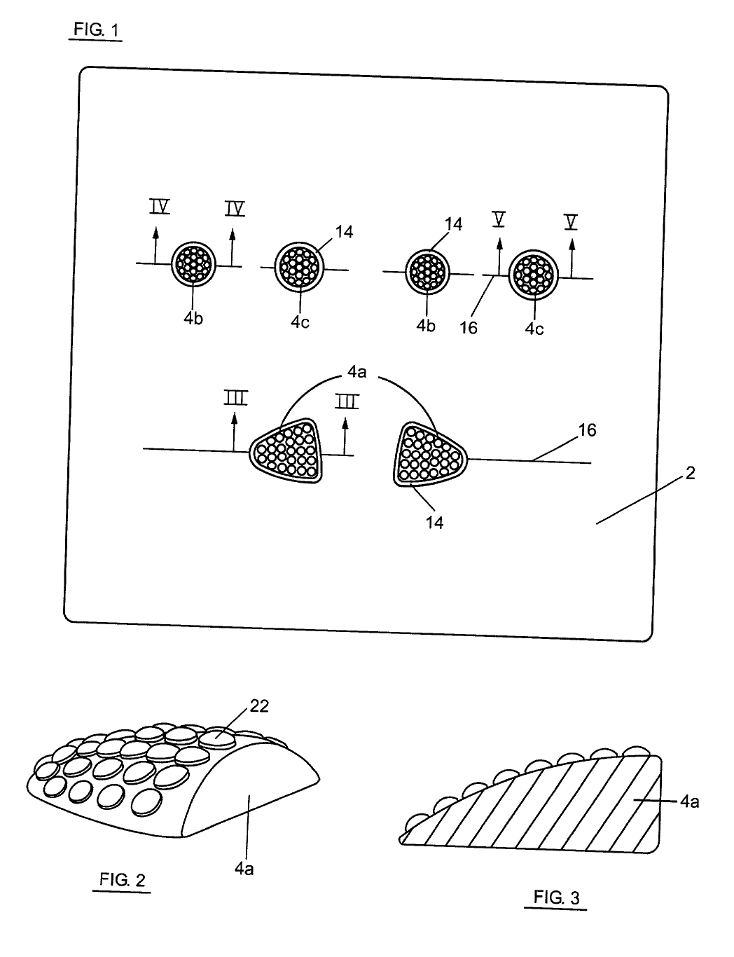

A preferred form of the device for achieving such treatment is shown in FIG. 1. It consists of a Floorboard or panel 2 with a series of pads 4 mounted thereon. Preferably the floorboard is a sheet of cross-linked polyethylene foam (Toilon Company produces and adequate foam, obtainable from PAC Foam products in Costa Mesa, Calif., U.S.A.), or a polyolefin or minicel closed cell foam, the sheet being about ¼ to ⅜ of an inch thick and of an overall size of about 28 inches by 30 inches. The density of the foam should be such that standing on it is comfortable—the foam gives somewhat to cushion the foot—but during use the pads apply an adequate pressure to the arches, as described herein, and the foam readily resumes it flattened panel shape when the user steps off it. A foam density of about 3 to 4 pounds per cubic foot is satisfactory.

Preferably three pairs of pads are provided, pad pairs 4a, 4b and 4c. Each set of pads may be made of a fairly rigid foam material, or a fairly rigid rubber. An approximate shore “A” 15 to 25 hardness of polyvinylchloride (PVC), silicone, polyurethane rubber type material or a fairly rigid foam is adequate. Others may prefer harder or softer pads. Pads 4a are shaped generally like the toe opening of a shoe; a perspective of one of pads 4a as shown in FIG. 2, and a lateral cross-sectional view through lines III-III o f FIG. I is shown in FIG. 3. In general, pads 4a are shaped to approximate half of a cone with a rounded top. In the preferred device each pad 4a is about ¾ of an inch thick at its maximum, about 3 inches long, and about 2½ inches wide at its widest portion.

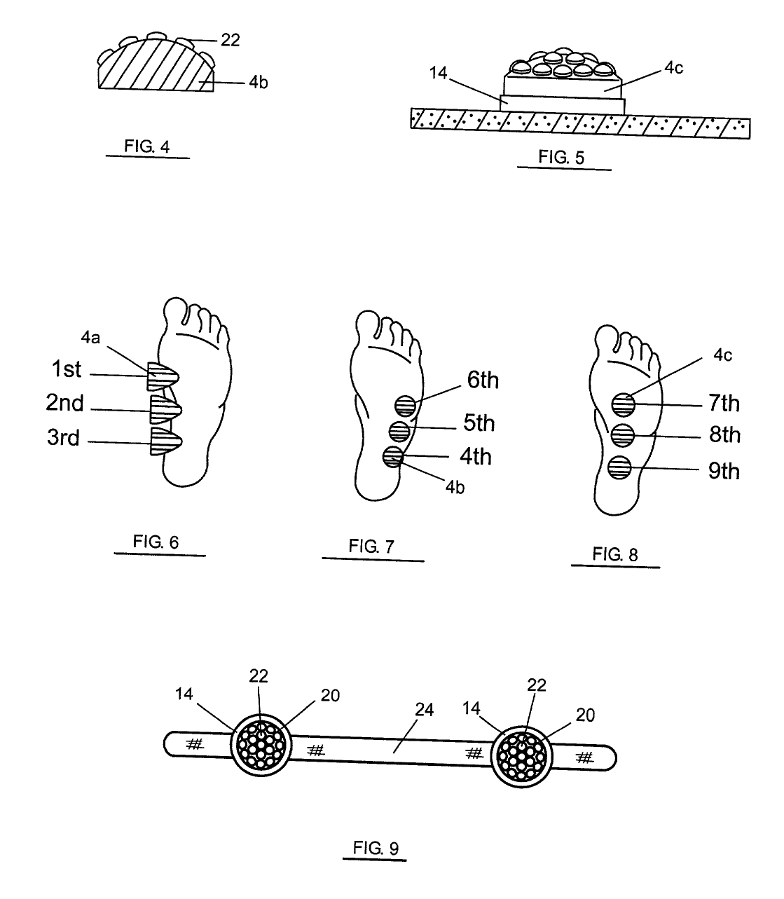

Each of pads 4b and 4c are shaped generally like a portion of sphere, as shown in cross-section in FIG. 4 and in perspective in FIG. 5. Pads 4b are somewhat smaller than pads 4c for a reason that will be stated shortly. The width of pads 4b is about 1½ inches, and their height is about 7/16 an inch. The width of pads 4c is about 1½ inches, and their height is about ½ an inch. On the upper surface of each pads 4a, 4b, and 4c preferably is a series of projections or protuberances 6, each being generally rounded or sphericle in shape. A ¼ inch hemisphere is satisfactory for each of the protuberances. Of course, different sized or shaped protuberances may be used, and might be preferred by others. The protuberances assist in applying pressure to the portion of a foot that rests on the pad, permitting tissue to settle into the spaces between the protuberances while allowing the protuberances to apply pressure to the muscles, tendons and bones of the foot without impeding microcirculation. In this fashion, the pads and their upper surfaces stimulate the musculature associated with the arch over the pressure point to return to its natural or intended form in the foot.

Preferably the pads are attached to the floorboard, each by a piece of double-sided tape (Avery brand #333 or the like is adequate or a silicone adhesive for silicone pads). The pads should be located generally as shown in FIG. 1, each pair of pads being far enough away from the other pairs to permit their use in a manner to be described shortly. An appropriate location for pads 4a positions them along a horizontal line about 9⅜ inches above the lower edge of floorboard 2. Pads 4b and 4c should be about 18¾ inches above the lower edge. The pads of each pair are spaced apart a distance approximating the distance between the user's hip joints, thereby to allow the user to stand directly over the pad pairs during treatment, and causing the applied forces to oriented in line with the user's body architecture. Pads 4a may be positioned by the user with a 7-15 degree turnout to accommodate for the normal flick angle (foot turn-out) associated with normal stance.

Larger, heavier people require a greater force to be applied to their feet to achieve the recommended definite, significant but not uncomfortable pressure exerted by the pads. In general the recommended force applied to the user's feet is proportional to the user's weight, which in turn is proportional to the musculature and bone sizes of the user's feet. Thus, using the weight of the person standing on the pads to provide the force applied to the user's feet offers a natural, clear advantage. Also, the direction of the applied force should in general be perpendicular to the sole of the foot. Again, requiring the person to stand on the pads, which in turn are supported on a floor, achieves this orientation in a simple, natural fashion.

The pressure applied to the user's feet by the pads during use should be significant but not uncomfortable. Since different user's have different size feet, both in outer shape and in their inner structures, it is desirable to permit the user to increase the height of one or more of the pad pairs to achieve the stated pressure during use of the pads. One or more foam or sufficiently resilient material discs 14, shown most clearly in FIG. 5, may be positioned between the bottom surface of a pad and the top surface of floorboard 2, thereby to raise the height of the pad to an appropriate position. Each disc may be about ¼ inch thick and of a density of a bout 3 to 4 pounds per cubic foot in foam or of a shore “A” rubber or resilient material of a hardness between 10 and 25 is adequate. Pieces of double-sided tape or equivalent attachment means may be employed to attach the pad to a disc and the disc to the floorboard. Preferably, to assist the user in properly locating their feet during a treatment, the floorboard 2 may include appropriate indicia 16 to locate the pads even while covered by the user's feet.

A second, simplified device for adjusting or manipulating the bony architecture of the human foot which is also cross referenced from application Ser. No. 09/325,275, filed Jun. 3, 1999 is shown in perspective in FIG. 9. It consists of a pair of shells or semi-sphericle pads 20, each having a set of protuberances 22 distributed over its upper surface generally as shown, and for the purpose stated with respect to protuberances. Each pad may be of a fairly rigid foam material, or a rubber. Once again as in the first embodiment, a shore “A” 15-25 hardness polyvinylchloride, silicone or polyurethane or equivalent rubber or comparable material is suffice, although others may prefer a softer or more rigid hardness.

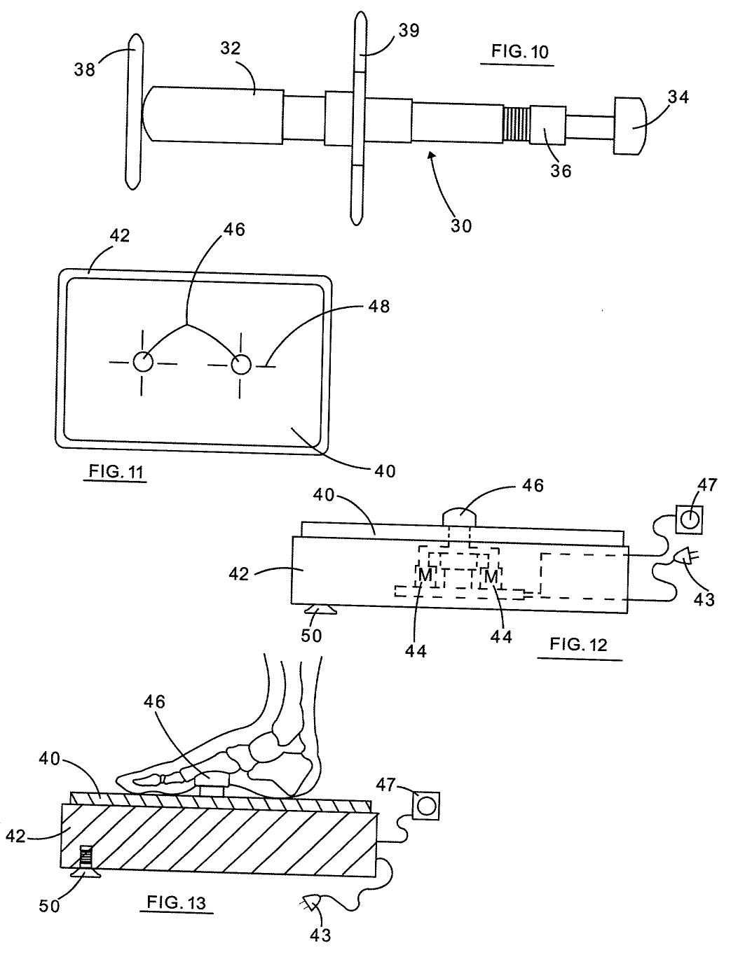

The present methodological invention utilizes the Activator Adjustment Instrument or a reflex gun adjustment instrument. The Activator Adjustment Instrument 30 is an established adjustment instrument typically utilized by some manual medicine practitioners, such as chiropractors or osteopaths to manipulate particular bony segments in the body. Other similar devices are sometimes referred to as Reflex Adjustment Instruments. Typically these devices as shown in FIG. 10 consists of a spring loaded mechanism, within a chamber 32 of the device that provides an impulse when manually -engaged. This impulse cause the rubber stylus tip or stimulating member 34 to engage the hard and soft tissues of the user's body with a high frequency generally low amplitude thrust delivered through the instrument. The amplitude of this force is adjustable by turning the barrel 36 clockwise or counterclockwise in order to adjust the tension and thus increasing or decreasing the force. In use the doctor engages the tissues to take out what is considered “tissue slack” and then delivers the impulse to the desired region by resting the base 38 in the palm of the hand and depressing handle 39. Other adjustment instruments may be automated and delivered through pneumatic, motorized or solenoid action.

Another device utilizing this methodological procedure is a self adjustment device, previously unknown, designed to provide an automated impulse that an individual can use to self-treat the bony architectural alignment of the foot, while in the seated position. The device shown in FIGS. 11, 12, and 13, consists of a surface board 40 of an approximate size of 20 inches by 18 inches to accommodate two human feet in the required positions and is attached to a base box 42 which contains an automated mechanism, motor or a means to provide an automated impulse to the feet. This device has a motorized unit 44 or similar means such as a pneumatic trigger or spring loaded mechanism, used to elicit the stimulus, causing the stylus tip 46 to engage the tissues. The stimulus is equal in intensity to that which is applied by a typical activator adjustment instrument. A release button 48 is of a material sufficiently resilient to not disrupt the bony alignment procedure during depression of the button by the user to elicit the automated stimulus. This may be have a button cover pad made of cross-linked polyethylene foam of a density of approximately 34 pounds per cubic foot. Two stylus tips 46 are provided of a rubber material or a like material sufficiently resilient to effect the method, one for each foot is positioned approximately hip's width apart. Preferably the stimulating members or stylus tips are of a size approximately ⅝ of an inch in diameter is sufficient to apply pressure to the indicated position designated in the methodology. A stylus tip equal to that on an Activator Adjustment Instrument is satisfactory, although a softer stylus tip may be preferred by others. Surface board 40 is of a material sufficiently resilient to maintain the bony architectural alignment of the foot once the procedure is applied. This may be made of cross-linked polyethylene foam of a density of approximately 3 to 4 pounds per cubic foot and approximately ¼ inch thick. Preferably, to assist the user in properly locating their feet during a treatment, the surface board may include appropriate indicia 48 to locate the pads even while covered by the user's feet. This device is intended for use while the user is in the seated position. The surface board may be angulated or tilted for comfort by raising or lowering the adjustable supports 50.

Self-adjusting one's own feet in a non-weight-bearing position is beneficial for those not able to utilize the previously disclosed devices in the cross referenced application Ser. No. 09/325,275 filed Jun. 3, 1999. Those not able to utilize the original devices due to the inability to stand on the pads unassisted from injury or even paralysis, may benefit from such an automated device. The Activator Adjustment Instrument may utilize the disclosed non-bilateral simultaneous stimulation of the necessary points when performed by another individual, such as a caretaker providing treatment. Both devices provide an advantage over the previous filed application, due to their substantially passive nature of application that eliminates the requirement of the individual being treated to have to stand in a weight-bearing position to receive treatment.

Theory of Operation or Effects

While the applicant believes the effects occur because of the following reflex pathways, he does not wish to be bound by this theory of operation or effects.

The autonomic nervous system (ANS) is often described as automatic because it is concerned with involuntary bodily functions. This self-controlling neurologic mechanism through its attachments to specialized nerves, muscle fibers and glands influences the function of all bodily systems.

The ANS is divided into two controlling portions, the sympathetic and parasympathetic systems which produce equal and opposite effects on the body in order to maintain a state of equilibrium. When functioning optimally, the ANS is capable of effectively responding to stimuli and is considered to exhibit normal sympathetic and parasympathetic tone. The importance of normal tone is that it allow the nervous system to effectively increase or decrease the activity of an organ, gland or muscle in order to maintain homeostatic mechanisms throughout the body.

The ANS operates largely through reflexes in which sensory signals originating from receptors in the visceral or sensory organs, are received by nerve centers within the hypothalamus, brainstem or spinal cord. The response is effected through motor impulses which travel out of the CNS through peripheral nerve fibers within the cranial and spinal nerves. Attachments to various muscles or glands effect the appropriate response by contracting, secreting substances or inhibiting secretions.

There are 31 pairs of spinal nerves that originate from the spinal cord. They carry both sensory and motor nerve fibers. Each spinal nerve emerges from the cord by two short branches, or roots, which lie within the vertebral column. The sensory root is identified by an enlargement called a ganglion which contains cell bodies of sensory neurons. The motor root contains axons from motor neurons whose cell bodies are within the spinal cord. A sensory and motor root unite to form a spinal nerve, which passes out the spinal canal through an opening between the vertebra called the intervertebral foramen (IVF). Just beyond the IVF each spinal nerve divides into further branches connecting the CNS to various body regions.

Spinal reflex pathways describe the routes that interconnect sensory and motor nerves to create an automatic response. Muscles, tendons, ligaments and joint capsules have specialized nerve receptors, namely mechanoreceptors, that monitor joint position. A reflex arc is formed with the connection of these sensory fibers to motor nerve fibers which operate entirely at a subconscious level. Through this reflex mechanism several essential spinal reflex pathways exist that contribute to posture and motion:

1. Stretch & Tendon Reflexes: Deformation of muscle receptors in the belly (spindle cells) or tendon (golgi tendon organs), initiates reflex contraction.

2. Flexor Reflex: Withdraw reflex that occurs from pain, causing flexor muscle contraction.

3. Crossed Extensor Reflex: Occurs after Flexor Reflex with the opposite limb extending.

4. Positive Support Reaction: Pressure on the footpad causes the limb to contract its extensor muscles for postural support.

5. Rhythmic Stepping Reflex: Forward flexion of the limb is followed by backward extension.

Although not a true spinal reflex, the ANS reflex arc combines with the spinal nerve to reach various body parts. One extremely important system with wide spread effects on the body is activated by sympathetic stimulation of the adrenal glands. This in turn causes the release of large quantities of stress response hormones into the circulating blood and are carried to all tissues throughout the body. These hormones have nearly the same effect as direct sympathetic nerve stimulation, except hormonal effects last approximately ten times longer. This reflex can be initiated through structural, biochemical or mental forces, but all forces ultimately interact in the body's effort to maintain homeostasis.

The proper positioning of the 26 bones of each foot is essential to maintaining its arches, providing for optimal body alignment and functioning. This allows the foot to properly absorb and propel motion and force throughout the body. Specialized nerve receptors in the feet, collectively referred to as proprioceptors, are responsible for maintaining posture, coordinating movement, and controlling our autonomic (automatic) nervous system function.

Today, most people wear shoes and walk on hard, flat surfaces. Both of these conditions are unnatural; the raised heel used as part of most shoes adds to the unnatural forces applied to the foot, while hard, flat surfaces do not yield their forces to the adaptable human frame.

Newton's Third Law of Reaction states that for every action there is an equal and opposite reaction. Motion loss and structural disorganization of body tissues is the “equal and opposite reaction” of the human body's interaction with static, non-yielding forces, such as inappropriate footwear and hard, flat surfaces. Since the body is adaptable, it will strive to adjust to these unnatural forces, seeking stability at the expense of loss of mobility.

The initial site of adaptive change in the body are the feet. Limitation or excessive motion to the primary functions of the foot creates structural adaptations throughout the body. Faulty nerve signals are transmitted through nerve receptors located in the feet, triggered by joint misalignment and deformation of nerve laden tissue.

Altered nerve signals are referred to as faulty although it must be realized that nerve signals are neither correct nor faulty, they are simply electrical and chemical messages transmitting the received stimuli. They are referred to as faulty throughout this text in order to describe the degenerative effects that ensue from such aberrant signals. Such faulty nerve signals, through spinal reflexes, create muscular weakness and postural imbalance throughout the body, altering autonomic nervous system function.

Faulty foot mechanics can cause painful conditions of both local and widespread reflex dysfunction. Neurological patterns of posture, gait, and movement are disturbed. Organ and glandular conduct of the body is adversely affected through nervous and circulatory compromise. Diminished respiratory and metabolic efficiency occurs as well as an overall loss of energy to the system. Prolonged stress of psychic, postural, or mechanical origin creates adaptive pathological changes to the tissues.

Titling of the skeletal elements by heeled shoes, not only disrupts the structural balance of the human body, but also creates a constant physiological stress response through the autonomic nervous system. Positioning of the weight on the forefoot mimics the “fight or flight” posture of the foot. Altered foot posture sends reflex stress signals from muscle and joint proprioceptors in the foot, preparing the body to take action. Diminished respiratory efficiency occurs while in this abnormal posture resulting in reduced oxygen intake, compromised circulation, and dimunition in both physical and mental capacity.

Constant bombardment of faulty nerve signals from sustained altered foot position creates physiologic exhaustion. Through the release of stress hormones into the blood, all tissues in the body are affected. Structural, biochemical and mental effects of the stress response accelerate the aging process, leading to premature degenerative changes throughout the body's tissues.

The General Adaptation Syndrome as described by Hans Seyle, a French physiologist, documents the physiologic effects of stress. When applying these principles to an altered biomechanical state of the human body, the effects of stress can be seen throughout the body in some of today's most common health disorders.

The following process describes the pathophysiology involved in this reflexive process.

Faulty body alignment begins with the structural breakdown of the ligaments of the feet distorting the intended bony alignment. Joint capsules and muscles con tain specialized nerve receptors called mechanoreceptors. Mechanoreceptors relay information to the nervous system regarding joint position, for appropriate biomechanical and physiological responses. Even slight deformation of the joint capsule or muscle, relays faulty or aberrant nerve signals throughout the body initiating the stress response. This stimulates spinal reflex pathways to alter muscle tone in attempts to maintain stability.

Stimulation of sympathetic nerve fibers to the adrenal glands causes stress hormone release into the blood which circulates and affects all tissues throughout the body. The circulating hormones have almost the same effects on organs in the body as those caused by direct sympathetic stimulation, except that the effects last approximately ten times longer. These effects include: constriction of essentially all blood vessels in the body; increased activity of the heart, inhibition of the gastrointestinal tract; dilation of the pupil of the eye, and so forth according to sympathetic innervation.

Altered muscle tone and postural imbalance lead to further structural and physiologic stress, altering the body's structure, biochemistry and mentality. Premature degenerative changes ensue affecting all tissues in the body, accelerating cellular disorganization and energy loss to bodily systems

From a biomechanical perspective, in order to prevent, slow or delay the onset of mechanically induced degenerative conditions, correction of the structural integrity of the feet must first occur . Although the concept of improving the biomechanical functioning of the human body through the alignment of the feet is not new, the diagnosis, methodology for correcting and response to treatment is new.

The Neutral Balance Effect (NBE) as introduced by this applicant, describes an optimal biomechanical state that can be achieved and subjectively and objectively measured through the structural and physiological assessment of the human body. This effect appears to occurs only when the bony architecture of the feet have been restored to their normal intended alignment and functioning or an improved state of alignment . In essence, they assume a neutral balanced body position reflected in improved body posture, strength and function. The following effects are based upon physiological principles of human structure and function.

Nerve, muscle, bone and cartilage is aided by the restoration of optimal body alignment. Transmission of proper biomechanical forces throughout the body re-establishes optimal form through the remodeling of hard and soft tissues. Reduced biomechanical stress and ease of movement reserves energy for all bodily systems, assisting in the maintenance of homeostasis. The musculoskeletal system consumes approximately 60% of the body's total energy. Increasing the efficiency of this system alone has the potential for significantly increasing energy reserves to the individual and all body systems.

Proper nerve signals emanating from the feet restore postural balance and positively affects autonomic nervous system (ANS) tone. Alleviation of repetitive adrenal stimulation from stressful sensory stimuli is diminished through the strengthening and restoration of body alignment.

With improved nervous system tone, the endocrine system is able restore its delicate hormonal balance with nature and the body's internal environment. Reproductive system function is improved with increased pelvic motion resulting in improved circulation and sexual and reproductive function. Removal of nerve interference from altered biomechanics improves ANS function and hence reproductive function. Proper reproductive organ support and alignment from a balanced pelvis is beneficial in preventing against common disorders associated with stasis, infection, infertility and sexual dysfunction.

Proper nervous system tone improves digestive function by improving the rate of movement, absorption and glandular secretions. Proper muscle tone of the abdomen provides the intended support for the abdominal organs. This prevents ptosis, compression of vital organ tissues and circulatory compromise. Restored diaphragmatic and intercostal muscle tone through proper pelvic and rib cage alignment helps to prevent malpositioning of the stomach and esophagus. This may prevent reflux esophagitis (heartburn).

The heart and circulatory system are directly controlled by the ANS regulating blood pressure and heart rate. Optimal body alignment reduces the stress on the heart by decreasing the workload necessary to pump blood through its vessels. With diminished peripheral resistance due to proper body alignment, less damage occurs to arterial walls as vessels are released from previously distorted connective tissues. Improved ANS tone also improves blood vessel tone to the smooth muscles that surround the vessel walls improving circulatory response and efficiency.

Immune function is also improved with the NBE due to improved muscle tone. This increases circulation of lymph and effectively improves the immune response. Diminished stress levels also contribute to improved immune function.

Improved neurologic function and circulation ultimately affects our mentality and emotional being. Most degenerative conditions of the brain are due to neurologic dysfunction or diminished blood or oxygen supply. Improved respiratory and metabolic function through improved diaphragmatic breathing improves metabolic efficiency, oxygenation of blood, and cerebral (brain) circulation.

Proper body weight distribution associated with restoration of body alignment, obviates the need for the body to deposit excess fatty tissue to support faulty weight bearing joints. This improves respiratory, metabolic and circulatory processes.

Operational Use

To use the preferred device cross referenced in the previous application, first the pairs of pads are positioned appropriately spaced from one another as previously described. Once all three sets of pads are appropriately positioned, the user proceeds to employ the pads to achieve an adjustment.

First, the user stands on pads 4a with each pad bearing the user's medial longitudinal arch, the left pad on the left arch, the right pad on the right arch, each foot being turned outward as comfortable, normally about 7-15 degrees. The pads are sized such that they will only bear on a portion of the arch. In a first position, the user stands on pad pairs 4a with each pad being located under the foot's joint between the first metatarsal and first cuneiform bones. The height of these pad pairs increases from an outer minimum to an inward maximum. The user stands on the pads so that each applies a significant pressure to the foot, but not an uncomfortable pressure. The first position, the relation of pad 4a to the user's left foot, is shown in FIG. 6, the position being marked “1st.” The user should remain standing with each foot in this position on its pad for 10 to 15 seconds, or the amount of time required to take two to three normal breaths.

Next, the user shifts the position of his or her feet on pads 4a so that, in a second position, the pads bear on the user's navicular bone. Preferably, each time the user changes position on the pads, if the user is right-handed the right foot is removed first, then the left foot. The right foot is placed on the next pad or in a the next position on the same pad, after which the left foot is placed. If the user is left-handed, the left foot is moved and placed first; in other words, the “handedness” of the user determines the order in which the feet are moved and placed. Ambidextrous individuals should consider the handedness side to be the side that the individual writes with or performs fine motor manipulation best. A foot is appropriately placed on a pad, and the pad height is appropriate, when the location of the foot is as stated and the pressure exerted on the foot by the pad is firm but not uncomfortable. The second position, specifically the relation of pad 4a to the user's left foot is shown in FIG. 6, the position being marked “2nd”.

After remaining in the second position for between 10-15 seconds, or for two to three breaths, the user moves to a third position on pads 4a in which the pads underlie the rear part of the talus bone of the user's feet, and the pads exert the indicated pressure on the foot. This position on the user's left foot is shown in FIG. 6, the position being marked “3rd.” The user remains in this position for 10-15 seconds. This completes application of an adjustment to the user's medial longitudinal arches.

Next the user steps off pads 4a, the handedness foot always being moved first, then onto pads 4b such that they are located beneath the joint of the cuboid and calcaneus bones of each foot. They should exert definite but not uncomfortable pressure on each foot. The fourth position, specifically the relationship of pad 4b to the user's left foot, is shown in FIG. 7, the position being marked “4th.”

After remaining in this fourth position for between 10 to 15 seconds, or for two to three breaths, the user moves to a fifth position in which pads 4b are located under the joint between the fifth metatarsal bone and the cuboid bone. The applied pressure should be as previously stated, and the time of application should be between 10 to 15 seconds. The fifth position, no specifically the relationship of pad 4b to the user's left foot, is shown in FIG. 7, the position marked “5th”. Of course, the user's right foot is similarly positioned, both in this position and in all other positions, except when dismounting from the board in the final position later described, dependent on the handedness of the individual, thereby to use the pad pairs to simultaneously apply pressure to the soles of both the user's feet.

Next, the user moves to sixth position in which, for each foot, pad 4b underlies the center of the fourth metatarsal bone, as designated by FIG. 7 by “6th.” Again the applied pressure should be as previously stated, and the position should be held for 10-15 seconds.

The next three positions adjust the transverse arches. In a seventh position, the user's feet are moved to pad pairs 4c, each pad underlying the center of the second metatarsal bone, as shown in FIG. 8, the position being marked “7th.” The applied pressure should be as previously stated, and the position should be held for 10-15 seconds.

The eighth position locates the user's feet such that pads 4c are each under the joint between the user's second and third cuneiform bones, as shown in FIG. 8 and labeled “9th.” The position should be held for 10-15 seconds and the pressure applied should be definite but not uncomfortable. In exiting this position, the handedness foot is removed first, following which pressure is continued to be applied by pad 4c to the other foot for between 10 to 15 seconds, after which it is removed to complete the treatment or exercise.

A second, simplified device for adjusting or manipulating the bony architecture of the human foot is shown in perspective in FIG. 9. It consists of a pair of shells or semi-sphericle pads 20, each having a set of protuberances 22 distributed over its upper surface generally as shown, and for the purpose stated with respect to protuberances 6. Each pad may be of a fairly rigid foam material, or a fairly rigid rubber. Once again as in the first embodiment a shore “A” 15 to 25 hardness of polyvinylchloride, polyurethane or equivalent rubber or comparable material is suffice, although others may prefer a softer or more rigid hardness.

In use, and as with the pads of the device shown in FIG. 1, each pad should apply a definite and significant but not uncomfortable pressure to the sole of the user's foot adequate to reposition the bony architecture effected by this method. Since different user's feet are of different size and shape, it is necessary to use this device on a soft, yielding surface such as on a rug, the softness yielding somewhat to accommodate feet of different size and substantially sufficient to maintain the repositioning of the foot's bony architecture effected by the method. Should greater pressure be desired, one or more discs like disc 14 may be attached to the bottom of pads 20 to raise their upper surfaces relative to the rug on which the device is being used. The pads are preferably connected to one another, such as by strap 24 extending through appropriate slots in each of the pads. The pads may slide along the strap to adjust their spacing to approximate the distance between the user's hip joints. The strap also helps to hold the pads upright with their top surfaces ready to receive the user's feet. To use this device, the user positions each foot on one of the pads, going through positions 1 to 9 as previously described, each position preferably being held for from 10 to 15 seconds although not necessary. As before, the handedness foot should preferably be moved first. Also, the last position is held on the non-handedness foot for an extra 5 to 15 seconds, but the duration is not absolutely necessary,

It may seem, especially those not attuned to the biomechanics and energy balances of the human body, that these devices are, to say the least, simple. They may even consider them to be of little or no practical use. This, however, is certainly erroneus. Those familiar with AK know that simple muscle tests can quickly and clearly reveal the effectiveness on the human body of many different treatments. Using such AK muscle testing, it can be shown that appropriate treatments will restore the body's natural biomechanics and energy balances, as evidenced through manual muscle testing procedures, along with standard methodologies of human neuromusculoskeletal assessment. Such measurements may include, range of motion, postural analysis, gait analysis, manual muscle testing, respiratory capacity, vertebral and extremity motion palpation and point tenderness to palpation, amongst other standard diagnostic testing procedures. It can also be shown that unnatural or adverse conditions will upset such qualities, sometimes with surprising speed. By employing such tests, it can be shown that using this device but not substantially in the manner described will not restore such qualities. Thus, a treatment proceeding for example through the positions in the order 1, 4, 7, 2, 5, 8, 3, 6 then 9 will not restore such qualities, nor will one proceeding through positions in the order 1, 2, 3, 7, 8, 9, then 4, 5 and 6. Restoration can be obtained by a sequence of positions 1, 3, 4, 6, then 7 and 9—in other words by omitting or combining positions 2, 5 and 8 with their adjacent positions. Also restoration can be obtained by using the full numerical sequence of positions as stated, yet not holding each for the full 10-15 seconds or the suggested one to two breaths, but rather for a shorter period. However, clearly a treatment employing the full sequence of positions 1 to 9 in numerical order and by holding each position for one to two breaths or for the full 10 to 15 seconds is best to achieve the full benefit of sensory stimulation and the restoration of such qualities of an optimal biomechanical state available using this method and either of the disclosed devices.

Of course, others may prefer to apply pressure to additional areas of the foot, or in a more elaborate or somewhat different sequence, or using different shaped pads (standing on bottle caps in the order stated has even produced some benefit); experience using the devices and methodologies of this invention may suggest further treatment modalities or changes to better suit certain conditions or people. But this method and each device is simple, employs the user's own weight and the force of gravity to effect treatment, and because it is self applied it can be employed as often as desired or as necessary. Twice a day, at arising and in the evening, usually will be sufficient. But if unusual or adverse biomechanical stresses have been encountered, or inappropriate footwear has been worn, or if the user has stood barefoot on hard, flat unnatural surfaces for any period of time, more frequent use of either the device and the method will be desirable. By appropriately repositioning the bony architecture of the feet on a regular basis, the structure and musculature of the foot can be induced to revert to their natural, intended alignments and functions of the user's body.

It is important to use each of the devices, and to perform the steps of the method, on a floor that is sufficiently resilient to not negate or substantially reduce the adjustment of the bony architecture of the user's feet. Put differently, it has been found that a foot's bony architecture, and the body's biomechanics and natural energy balances, once readjusted or restored, are almost instantaneously upset if the person stands on a hard, flat surface such as concrete or a tile floor. Many shoes also have this effect. On the other hand, when the natural architecture of a person's feet has been restored, if the person then stands on, or walks on, a carpet or a well-cushioned rug, the natural architecture will tend to remain. This is also true if the person walks on dirt, sand or other natural, yielding or irregular outdoor surfaces. Thus preferably the devices are used when resting on a carpet or the like, and at least for an initial period of time the person who has used either of the devices, or the method, does not walk on a concrete-like surface.

The preferred method disclosed in the present application utilizes the Activator Adjustment Instrument or a reflex gun adjustment instrument. The Activator Adjustment Instrument 30 is an established adjustment instrument typically utilized by some manual medicine practitioners, such as chiropractors or osteopaths to manipulate particular bony segments in the body. Other similar devices are sometimes referred to as Reflex Adjustment Instruments. Typically these devices consist of a spring loaded mechanism, within a chamber 32 of the device that provides an impulse when manually engaged. This impulse cause the rubber stylus tip or stimulating member to engage the hard and soft tissues of the user's body with a high frequency generally low amplitude thrust delivered through the instrument. The amplitude of this force is adjustable by turning the barrel 34 clockwise or counterclockwise in order to adjust the tension and thus the force. In use the doctor engages the tissues to take out what is considered “tissue slack” and then delivers the impulse to the desired region.

The preferred device disclosed in the present application utilizes a self adjustment device, previously unknown, designed to provide an automated impulse that an individual can use to self-treat the bony architectural alignment of the foot, while in the seated position. The device shown in FIGS. 11, 12, and 13, consists of a surface board 40 of an approximate size of 20 inches by 18 inches to accommodate two human feet in the required positions and is attached to a base box 42 which contains an automated mechanism, motor or a means to provide an automated impulse to the feet. This device has a motorized unit 44 or similar means such as a pneumatic trigger or spring loaded mechanism, used to elicit the stimulus, causing the stylus tip 46 to engage the tissues. The stimulus is equal in intensity to that which is applied by a typical activator adjustment instrument and may be adjustable similarly. A release button 47 is of a material sufficiently resilient to not disrupt the bony alignment procedure during depression of the button by the user to elicit the automated stimulus. This may be have a button cover pad made of cross-linked polyethylene foam of a durometry of approximately 3 to 4 pounds per cubic foot. Two stylus tips 46 are provided of a rubber material or the like, one for each foot is positioned approximately hip's width apart. Preferably the stylus tips are of a size approximately ⅝ of an inch in diameter is sufficient to apply pressure to the indicated position designated in the methodology. A stylus tip equal to that on an Activator Adjustment Instrument is satisfactory. Surface board 40 is of a material sufficiently resilient to maintain the bony architectural alignment of the foot once the procedure is applied. This may be made of cross-linked polyethelene foam of a density of approximately 3 to 4 pounds per cubic foot and approximately ¼ inch thick. Preferably, to assist the user in properly locating their feet during a treatment, the surface board may include appropriate indicia 48 to locate the pads even while covered by the user's feet. This device is intended for use while the user is in the seated position. The surface board may be angulated or tilted for comfort by raising or lowering the adjustable supports 50.

The preferred method of treating the bony architecture of the human foot uses at least one stimulus stylus tip. It includes the steps of applying a definite but comfortable pressure stimulus when the stylus tip is engaged into the tissues to perform the adjustment. The stimulus is sufficiently engaged through the spring loaded mechanism or similar means to apply an adequate pressure stimulus to realign the natural bony architecture. Varying sizes of stylus or even hardness of stylus tips may be easily added to the device to accommodate varying foot types, however the standard size is adequate for most individuals employing the device and methodology. First, the medial longitudinal arch of the user's handedness foot is stimulated using the stylus tip mechanism. As in FIG. 6, positions 1 through 3 (shown with triangular pads or stylus tips, but is typically accomplished in this method with a circular pad shape as shown in FIGS. 7 and 8) are stimulated with one to two impulses. For the right handed individual, this would be the right foot. For the left handed individual this would be the left foot. Ambidextrous individuals should consider the hand that they write with as their handedness side. Second, the user applies a definite but comfortable pressure stimulus to the lateral longitudinal arch as indicated by positions 4 through 6 in FIG. 7 of the user's handedness foot, and then applies a definite but comfortable pressure stimulus to the transverse arches as indicated in FIG. 8 as indicated by positions 7 through 9 of the user's handedness foot, thereby to effect an adjustment of the handedness foot's bony architecture . Next, the user applies the same definite yet comfortable stimulus pressures to the non-handedness foot. The non-handedness foot is considered the left foot for right handed individuals, and the right foot for left handed individuals. The non-handedness foot is stimulated with the same successive steps utilized for the handedness foot, beginning with the medial longitudinal arch positions 1 through 3, then the lateral longitudinal arch, positions 4 through six and finally the transverse arches, positions 7 through 9. As with the bilateral simultaneous point stimulation, positions 2, 5 and 8 may be omitted when utilizing this unilateral point stimulation method employing the stylus tips. This means there are only six positions that need to be stimulated on each foot to obtain an optimal biomechanical state. However, all nine positions on each foot are recommended to provide a full stimulation sequence to address all regions of the arches. By using the stimulus stylus tips in this preferred manner, the user obtains maximum benefit from the treatment.

When the individual is self applying this mechanized stimulus device, utilizing this unilateral point stimulation method, ultimately applied to both feet sequentially, the user is in a seated position. When this unilateral point stimulation method is applied by a caregiver, the person being treated is in a nonweight bearing position either seated, supine or prone.

Manual muscle testing is a practical, effective diagnostic tool used to obtain objective information regarding, amongst other things, the biomechanical functioning of the human body. Many of the testing techniques were originally developed to evaluate for motor loss from poliomyelitis. Muscle function was graded from no palpable contraction to normal strength. From this background, manual muscle testing as used in applied kinesiology was developed. Applied kinesiology muscle testing is a much more discernable type of muscle testing to how muscle function is adapted to nervous system stimulation. Strong and weak muscle testing responses represent a compensatory pattern of serial biomechanical distortions, when the body is not in an optimal biomechanical state. This affects muscle performance and the structural and physiological integrity of the body.

For purposes of clarifying the type of muscle test used, we will refer to the testing procedures used to evaluate the Neutral Balance Effect, as NBT (Neutral Balance Testing) procedures, as introduced by this applicant. The first test performed is the NBT Flexor Test and represents the strength of flexor muscle groups in the body. This test primarily utilizes the anterior deltoid musculature for assessment. Both left and right sides of the body are tested. The test is performed in the following manner by the primary healthcare practitioner skilled in the art and science of manual muscle testing procedures.

The standing barefoot patient flexes their shoulder, keeping the elbow extended and the palm down. The one arm is raised to approximately 45-90 degrees of shoulder flexion. The examiner contacts the patient open handed on the dorsal aspect of the patient's distal radius and ulna, directing a pressure against the arm in a direction down and into extension, as the patient is instructed to resist or hold their position. A strong muscle test response allows the patient to resist the force exerted by the practitioner on the outstretched arm, while the patient is in the barefoot standing position. A weak response causes the patient's arm to fall with no or minimal resistance to the practitioners force. The doctor notes either a strong or weak response.

The next muscle test performed is the NBT Extensor Test and represents the strength of the extensor muscle groups in the body. This test primarily utilizes the latissimus dorsi musculature for assessment. In this test, the standing barefoot patient's arm is held close to the body at its side, while the doctor tries to pull the arm away from the body. The standing patient holds their arm in adduction, with internal rotation, so the antecubital fossa faces medially. The examiner directs pressure against the distal aspect of the radius and ulna in a direction to abduct and slightly flex the shoulder. A strong muscle test response by the patient is indicated by the ability to hold their arm down and in close to the body, while a weak response allows the doctor to easily pull the arm away from the body. The test is performed on both right and left sides of the body and the practitioner notes the responses.

A weak response in any of the four individual muscle tests performed represent amongst other things, joint misalignment to the bony architecture of the feet and the resultant serial distortion that occurs throughout the body. Although the feet may appear visually normal in appearance or alignment to the untrained eye, foot imbalance exists until corrected through the use of the methodologies described in this application.

The ability of an individual to know whether or not their body is in an optimal biomechanical state is critical. Two self-administered biomechanical tests are introduced by this author that can be used to assess one's own biomechanical state: the NBT Abdominal Lock Test and the NBT Bi-Digital Cruciform Test Most people eventually begin to feel the specific differences in the way they feel when in an OBS: erect posture; deep relaxed breathing; and ease of movement, however these specific tests confirm an individual's state.

The Abdominal Lock Test (ALT) evaluates the tone of the abdominal musculature, which reflects among other things, the position of the pelvic bones. When a person is in an optimal biomechanical state (OBS), muscle tone is immediately increased throughout the body. Assessing this tone can be evaluated in either a standing or seated position. Here it is described in the standing position.

Test:

If the individual is in an OBS and completely relaxes his abdomen, or tries to extend the belly to a protruding “pot belly” position, they are restricted from doing so. The abdomen is flattened and the pelvis is locked into optimal alignment. However, when an individual is not in an OBS, the abdomen easily protrudes outward when standing. Bending forward at the waist when standing and observing either flattening or drooping of the abdominal wall can also be used to visualize this tone. This noticeable abdominal locking is a simple assessment that can be used to evaluate one's own biomechanical state. Over time an individual typically becomes automatically aware of this tone. The Bi-Digital Cruciform Test utilizes the pressure forces generated between both the flexor and extensor muscle groups of the individual's fingers.

Test:

With all fingers of the hand extended, and by simply crossing the middle finger of one hand over the index finger of the same hand, a light pressure can be effected between the two opposing muscle groups to simultaneously measure the strength between the fingers. Because an OBS strengthens muscles throughout the body, essentially any muscle group can be tested for strength. When the index finger cannot withstand the force of the middle finger pushing downwards, a weak response is generated, indicating faulty alignment or loss of an OBS. When in a n OBS, a strong response is elicited when both fingers equally resist each other's opposing forces and are able to maintain their extended positions.

After this assessment, the patient or individual can execute one of the disclosed methodologies in order to achieve an optimal biomechanical state or what this applicant describes as the Neutral Balance Effect. After completion, the individual is now reassessed. Postural alignment will typically show immediate improvement in both side and lateral views, with leveling of the bony landmarks and improvement towards the physiologically efficient normal gravity line of optimal postural alignment. Most notably to the patient besides the relaxed, yet alert state will typically observe the flattening or tonification of the abdominal wall and musculature.

With optimal skeletal alignment throughout the body, the typical protruding abdomen is retracted as a result of appropriate pelvic and spinal alignment. In some patients due to the extent of the initial postural distortion, due to previous significant injury, or extreme handedness of the individual, shoulder level may be slightly raised on one side, accounting for chronic hard and soft tissue contractures, consistent with degenerative changes to the tissues associated with acquired biomechanical dysfunction. Maintaining the Neutral Balance Effect over time will improve or correct the remaining distortion over time, helping to remodel the tissues to the newly balanced skeletal structure. Joint range of motion tests typically reveals improved motion in all directions occurring to joints throughout the body. Pain is typically diminished or eliminated, as well as point tenderness to palpation in many regions of the body. Provocative testing is generally negative for aggravation if not accompanied by a residual inflammatory condition to the tissues, from an acute or chronic injury or condition. Improved flexibility, range of motion and body alignment appears to increases respiratory capacity and produces an improved relaxed breathing pattern. With these benefits individuals typically experiences a decreased stress level and enhanced well-being. Manual muscle testing procedures are now re-performed, and muscle groups throughout the body typically test strong, as evidenced through both the NBT Flexor and Extensor Tests as well as individual muscles tests performed through standard AK testing procedures. This is the Neutral Balance Effect:: An optimal biomechanical state.

Maintaining the Neutral Balance Effect (NBE) or an optimal biomechanical state as introduced by this applicant is essential to creating long term physiologic changes in the body, to remodel tissues and improve function. As stated before, it has been found that a foot's bony architecture once readjusted or restored, will lose optimal alignment and functioning if the person stands or walks barefoot on a hard, flat surface such as concrete or a tile floor. Most shoes also have this effect, regardless of the surface environment encountered. However, when the natural architecture of a person's foot has been restored, and if the person stands or walks barefoot on a adequately padded carpet or well cushioned rug, the natural architecture will remain. This is also true if the person stands or walks on dirt, sand, grass or other natural surfaces. This applicant's U.S. Pat. No. 6,021,588 to Alviso, Feb. 8, 2000, describes a shoe assembly which has been shown to maintain this optimal biomechanical state, maintaining the natural architecture of the foot as evidenced through applied kinesiology muscle testing.

While preferred devices and methods have been shown and described, as indicated adjustments in the devices or method, or both, may be preferred by other care-givers or users. For that reason, and others, this invention should not be limited to either of the specific devices shown and described, or to the specific treatment stated, but rather is as set forth in the following claims.

1. A method for repositioning the bony architectural alignment of human feet providing a mechanical impulse based adjustment device with at least one stimulating member, in which the stimulating member is of a size sufficient to apply pressure to only a portion of an arch, the method comprising the steps of:
(a) using the stimulating member to first apply a sequence of definite pressures, sufficient to apply pressure to overlying muscles, tendons and bones of the individual's non-handedness foot to the medial longitudinal arch beginning with a forward area substantially underlying the foot's joints between the first metatarsal bones and first cuneiform bones, then applying at least a second separate applied pressures to the rearward area of the medial longitudinal arch substantially underlying the talus bones, then
(b) using the stimulating member to apply a sequence of definite pressures, sufficient to apply pressure to overlying muscles, tendons and bones of the individual's non-handedness foot to the lateral longitudinal arch, beginning with a rearward area substantially located under the joint between the cuboid and calcaneus bones, then applying at least a second separate applied pressures to the forward area of the lateral longitudinal arch substantially underlying the center of the fourth metatarsal bone, then
(c) using the stimulating member to apply a sequence of definite pressures, sufficient to apply pressure to overlying muscles, tendons and bones of the individual's non-handedness foot to the transverse arch including the longitudinal center, beginning with a forward area substantially located under the center of the second metatarsal bone, then applying at least a second separate applied pressures to the rearward area of the transverse arches substantially underlying the junction of the talus bone, cuboid, and calcaneum bones, then
(d) ending the method by repeating the same sequence of definite pressures, sufficient to apply pressure to overlying muscles, tendons and bones of the medial longitudinal arch, the lateral longitudinal arch and transverse arch including the longitudinal center of the individual's handedness foot or the foot on the ipsilateral side of the handedness side of the body.
whereby the intensity and duration of the applied stimulus impulse pressures are adequate to reposition the bony architecture of the feet effected by the method.

2. A method as set forth in claim 1 providing a carrier means which is a surface board of a size to permit the pair of stimulating members to be spaced apart sufficiently to permit pressure to be applied sequentially by each of the pairs to the arches of the foot without interference from the other stimulating member.

3. A method as set forth in claim 1 in which the stimulating members rest on a floor surface sufficiently resilient to substantially maintain the adjustment of the bony architecture of the feet effected by the method.

4. A method as set forth in claim 3 in which the stimulating members are engaged by a means of providing an automatic impulse.

5. A method as set forth in claim 4 in which the automatic impulse mechanism is engaged by use of a hand held button depression device, sufficiently resilient to not negate the effects of the method.

6. A method as set forth in claim 1 providing a means for substantially improving foot and body alignment and improving biomechanical functioning as measured through applied kinesiology manual muscle testing procedures and standard methods of physical assessment, including postural analysis.

7. A method of adjusting the bony architectural alignment of human feet, with the person's feet being treated are in a non-standing position, using a pressure applying member the method comprising the steps of:
(a) applying a first sequence of definite pressures to the person's handedness foot along the person's medial longitudinal arch beginning with a forward area and concluding with a rearward area including the first metatarsal, tarsal bones and talus, then
(b) applying a second sequence of definite pressures to the person's handedness foot along the person's lateral longitudinal arch beginning with a rearward area and concluding with a forward area including the cuboid and calcaneus bones and the metatarsal bones, then
(c) applying a third sequence of definite pressures to the person's handedness foot along the longitudinal center including the transverse arch beginning with a forward area and concluding with a rearward area underlying the metatarsal bones, the cuneiform bones and talus bones, then
(d) repeating the same sequence of definite impulses to the person's non-handedness foot or the contralateral foot of the handedness side of the body along the medial longitudinal arch, the lateral longitudinal arch and finally the transverse arches,
whereby the application of pressures being sufficient in intensity and duration to substantially effect the bony alignment of a person's feet.

8. A method as set forth in claim 7 in which the first applied pressures are applied to areas of the foot beginning with the forward area substantially underlying the foot's joints between the first metatarsal bones and first cuneiform bones, then applying at least a second separate applied pressures to the rearward area substantially underlying the talus bones, then
the second applied pressures are applied to area substantially located under the joint between the cuboid and calcaneus bones, then applying at least a second separate applied pressures to the forward area substantially underlying the center of the fourth metatarsal bones, then applying a third sequence of pressures to the forward area substantially located under the center of the second metatarsal bones, then applying at least a second separate applied pressures to the rearward area substantially underlying the junction of the talus bone, cuboid, and calcaneum bones.

9. A method as set forth in claim 8 in which the pressures are applied in a direction generally perpendicular to the bottom surface of the feet.

10. A method as set forth in claim 8 providing a means for engaging the bottom surface of the feet for the application of applied pressures.

11. A method as set forth in claim 8 providing a means for increasing or decreasing the amount of applied pressures.

12. A method as set forth in claim 8 providing a pressure method means for substantially improving foot and body alignment and improving biomechanical functioning as measured through applied kinesiology manual muscle testing procedures and standard methods of physical assessment.

13. A device for assisting in the biomechanical adjustment of human feet, the device comprising
(a) at least one impulse based stimulating member being shaped to apply pressure to the medial longitudinal arch of a foot, and to the lateral longitudinal arch of a foot, and to transverse arch of a foot, and
(b) the said member being capable of applying a definite pressure stimulus mechanized impulses, the application of pressures impulses being sufficient in intensity and duration to substantially effect the bony alignment of a person's feet, beginning with the medial longitudinal arch area at a forward area and concluding with a rearward area, and in which the next applied pressures are to the lateral longitudinal arch area beginning with a rearward area and concluding with a forward area, and in which the next applied pressures are applied to the transverse arch or longitudinal center beginning with a forward area and concluding with a rearward area substantially under the junction of the talus, cuboid and calcaneum bones, and finally making sure that the last pressure is applied to the rearward area substantially under the junction of the talus, cuboid and calcaneum bones of the non-handedness foot, and
(c) a carrier for positioning the feet approximately the distance between the hip joints upon the stimulating member(s).
(d) means for automating the stimulating member impulses whereby foot alignment is improved as effected by the method.

14. A device as set forth in claim 13 providing a means for applying the impulses substantially bilateral simultaneously, including the requirement of at least a second stimulating member.

15. A device as set forth in claim 13 in which the pressures are applied while the feet are in a non-standing position.

16. A device as set forth in claim 15 providing indicia on the upper surface of the surface board to assist in the placement of feet on the stimulating member and the application of forces to the arches.

17. A device as set forth in claim 16 providing a carrier surface is of a material sufficiently resilient to maintain the effects of the method

18. A device as set forth in claim 17 in which the pressures are applied in a direction generally perpendicular to the bottom surface of the feet.

19. A device as set forth in claim 18 in which the members are engaged by a means of providing an automated impulse.

20. A device as set forth in claim 19 in which the automatic impulse mechanism is motorized.
